(19) United States
(12) Patent Application Publication
(10) Pub. No.: US 2019/0359055 A1
(43) Pub. Date: Nov. 28, 2019

(54) ACCELERATOR PEDAL FOR VEHICLE

(71) Applicant: KYUNG CHANG INDUSTRIAL CO., Ltd., Daegu (KR)

(72) Inventors: Min Seong PARK, Daegu (KR); Bo Hee KU, Daegu (KR)

(21) Appl. No.: 16/410,278

(22) Filed: May 13, 2019

(30) Foreign Application Priority Data
May 25, 2018 (KR) 10-2018-0059575

(51) Int. Cl. B60K 26/02; G05G 1/44

(52) U.S. Cl. CPC B60K 26/02; G05G 1/44

(57) ABSTRACT

An accelerator pedal for a vehicle, which has a hysteresis generation structure, may be provided. The accelerator pedal includes: a housing which includes a pivot shaft; a pedal unit which includes a hinge connected pivotably to the housing; a first spring which is positioned under the pedal unit in such a manner as to be pressed downward when the pedal unit is pivoted; a friction member which is pivotably connected to the housing and contacts the hinge; a second spring which provides an elastic force to the friction member; and a force transmitting member which is positioned between the friction member and the second spring and transmits the elastic force of the second spring to the friction member.

### CROSS-REFERENCE TO RELATED APPLICATIONS

This application claims priority from Republic of Korea Patent Application No. 10-2018-0059575, filed on May 25, 2018, which is hereby incorporated by reference for all purposes as if fully set forth herein.

### BACKGROUND

### Field

The present disclosure relates to an accelerator pedal for a vehicle and more particularly to an accelerator pedal for a vehicle, which has a hysteresis generation structure.

### Description of the Related Art

An accelerator pedal allows a user to accelerate the rotation of an engine. When the user intends to accelerate by increasing the rotation speed of the engine, the user steps on the accelerator pedal. When the user intends to reduce the rotation speed of the engine, the user takes one's foot off the accelerator pedal. The accelerator pedal is connected to a throttle valve by wire and linkage. The throttle valve is opened by stepping on the accelerator pedal, so that air is introduced into the cylinder. Then, an electronic control fuel injection device detects the amount of air and supplies gasoline suitable for the engine operating condition.

The accelerator pedal includes a mechanical accelerator pedal and an electronic accelerator pedal. In the mechanical accelerator pedal, the throttle valve of the engine and the accelerator pedal are mechanically connected to each other by a cable. In the electronic accelerator pedal, the position of the pedal is sensed by a sensor and the operation of the throttle is controlled based on the sensed position signal.

The mechanical accelerator pedal causes operational problems due to ambient environment, temperature changes, the deterioration of the cable, etc. Therefore, at present, the mechanical accelerator pedal has been replaced by the electronic accelerator pedal. The electronic accelerator pedal requires no cable. Accordingly, the electronic accelerator pedal has advantages of having more installation space, of reducing the fatigue of a driver, and of improving the fuel efficiency.

However, the driver prefers tactile response felt by the driver in a conventional mechanical accelerator pedal. Also, in order to reduce the fatigue of the driver due to the operation of the electronic accelerator pedal, hysteresis must be generated. The hysteresis effect reduces the fatigue caused by the repeated operation of the driver.

A hysteresis generation technology applied to a conventional electronic accelerator pedal includes a structure friction method, a housing friction method, and the like. However, these methods have a complex structure and require a lot of parts.

### SUMMARY

A purpose of the present disclosure is to provide an accelerator pedal for a vehicle, which is capable of reducing ankle fatigue of a driver who operates the accelerator pedal repetitively.

Another purpose of the present disclosure is to provide the accelerator pedal for a vehicle, which is capable of providing the hysteresis effect with a simple configuration.

However, the object of the present disclosure is not limited to the above description and can be variously extended without departing from the scope and spirit of the present invention.

One embodiment is an accelerator pedal for a vehicle, which includes: a housing which includes a pivot shaft; a pedal unit which includes a hinge connected pivotably to the housing; a first spring which is positioned under the pedal unit in such a manner as to be pressed downward when the pedal unit is pivoted; a friction member which is pivotably connected to the housing and contacts the hinge; a second spring which provides an elastic force to the friction member; and a force transmitting member which is positioned between the friction member and the second spring and transmits the elastic force of the second spring to the friction member.

The accelerator pedal for a vehicle may further include a cover member which receives the second spring and into which a portion of the force transmitting member is slidably inserted.

The pedal unit may include a pivot hole into which the pivot shaft is inserted.

The friction member may have a first contact surface contacting a portion of the hinge and a curvature corresponding to a curvature of the hinge and may have a second contact surface contacting the force transmitting member.

The cover member may have a receiving hole which receives the second spring.

The force transmitting member may have an insertion portion which is slidably inserted into the receiving hole.

The housing may have a recess in which the first spring is installed.

### BRIEF DESCRIPTION OF THE DRAWINGS

FIG. 1 shows an accelerator pedal for a vehicle according to an embodiment of the present disclosure;

FIG. 2 is an exploded perspective view showing the accelerator pedal for a vehicle shown in FIG. 1 according to an embodiment of the present disclosure;

FIG. 3 is an exploded perspective view of a configuration which generates hysteresis in the accelerator pedal for a vehicle shown in FIG. 1 according to an embodiment of the present disclosure;

FIG. 4 is a perspective view showing the configuration which is positioned within the accelerator pedal for a vehicle shown in FIG. 1 and generates hysteresis according to an embodiment of the present disclosure;

FIG. 5 is a perspective view of a cover member of FIG. 3 as viewed from below according to an embodiment of the present disclosure;

FIG. 6 is a view for describing a principle of hysteresis generation in the accelerator pedal for a vehicle according to the embodiment of the present disclosure; and

FIGS. 7A and 7B are views showing the position relationship between a friction member and a force transmitting member according to an embodiment of the present disclosure.

### DETAILED DESCRIPTION

The following detailed description of the present disclosure shows a specified embodiment of the present disclosure and will be provided with reference to the accompanying drawings. The embodiment will be described in enough detail that those skilled in the art are able to embody the present disclosure. It should be understood that various embodiments of the present disclosure are different from each other and need not be mutually exclusive. For example, a specific shape, structure and properties, which are described in this disclosure, may be implemented in other embodiments without departing from the spirit and scope of the present disclosure with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereinafter, an accelerator pedal for a vehicle, which has a hysteresis generation structure according to an embodiment of the present invention will be described with reference to the accompanying drawings.

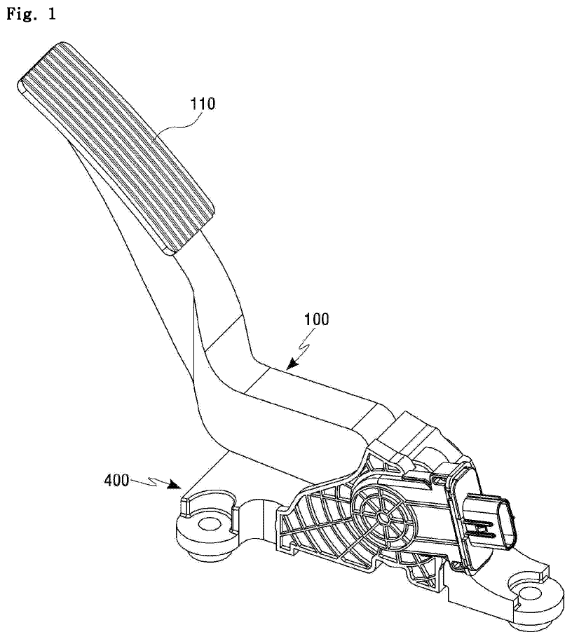

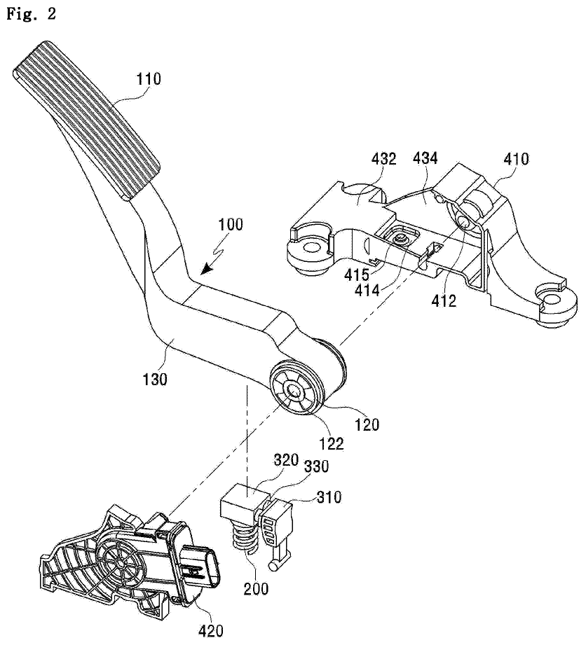

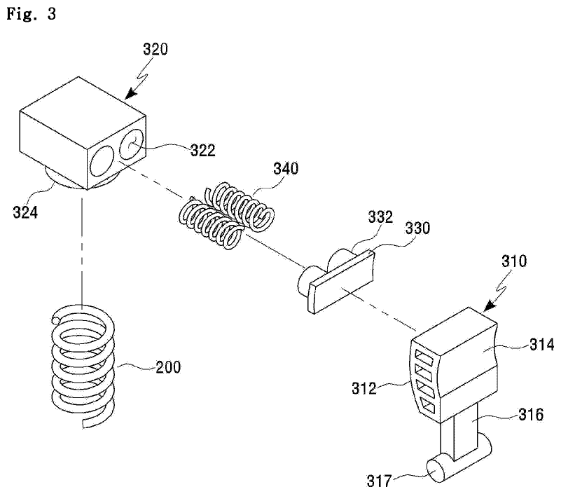

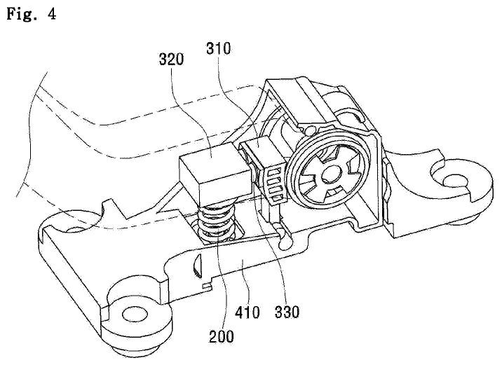

FIG. 1 shows an accelerator pedal for a vehicle according to an embodiment of the present disclosure. FIG. 2 is an exploded perspective view showing the accelerator pedal for a vehicle shown in FIG. 1. FIG. 3 is an exploded perspective view of a configuration which generates hysteresis in the accelerator pedal for a vehicle shown in FIG. 1. FIG. 4 is a perspective view showing the configuration which is positioned within the accelerator pedal for a vehicle shown in FIG. 1 and generates hysteresis.

Referring to FIGS. 1 to 4, the accelerator pedal for a vehicle according to the embodiment of the present disclosure may include a pedal unit 100, a first spring 200, a friction member 310, a force transmitting member 330, a cover member 320, and a housing 400.

The housing 400 includes a first housing 410 and a second housing 420. The first housing 410 includes a base 432 forming the bottom thereof, a sidewall 434, and a pivot shaft 412 protruding from the sidewall 434 approximately perpendicular to the sidewall 434. The pedal unit 100 is rotatably or pivotably coupled to the pivot shaft 412. Specifically, a hinge 120 of the pedal unit 100 includes a pivot hole 122 into which the pivot shaft 412 is inserted. The pedal unit 100 is pivotably connected to the pivot shaft 412 of the housing 400.

The pedal unit 100 includes a pedal pad 110 to which a driver applies a pedal effort, the hinge 120 which is connected to the housing 400, and a pedal arm 130 which connects the pedal pad 110 and the hinge 120. The pedal pad 110 may be formed to have a flat surface or may be outwardly curved at a predetermined curvature, in order to allow the driver to easily operate the pedal unit 100. The hinge 120 may have a cylindrical shape for allowing the pedal unit 100 to easily pivot.

The first spring 200 is positioned under the pedal unit 100 in such a way to be pressed downward when the pedal unit 100 is pivoted. The first spring 200 is installed on the base 432 of the first housing 410 in such a way to be pressed downward. The first spring 200 is installed in a recess 414 formed in the base 432 of the first housing 410. The recess 414 may include a protrusion 415 which is formed in the center of the recess 414 and fixes the movement of the first spring 200.

The friction member 310 is pivotably coupled to the housing 400 and contacts the hinge 120 of the pedal unit 100. One end of the friction member 310 is pivotably fixed to the housing 400 and the other end of the friction member 310 contacts the hinge 120. When the pedal unit 100 is rotated by the pedal effort, a frictional force is generated between the friction member 300 and the hinge 120 of the pedal unit 100 by the rotation of the hinge 120.

The friction member 310 has a first contact surface 314 and a second contact surface 312. The first contact surface 314 contacts a portion of the hinge 120 of the pedal unit 100. The second contact surface 312 contacts the force transmitting member 330. The first contact surface 314 may have a curvature corresponding to the curvature of the hinge 120. While FIG. 3 shows that the contact surface of the friction member 310, which contacts the surface of the hinge 120, has a curvature, the contact surface of the friction member 310 can be formed as a flat surface without being limited to this. Also, the friction member 310 includes a shaft 317 rotatably fixed to the housing 400. The friction member 310 may include a connection portion 316 which connects the shaft 317 and the portion contacting the hinge 120.

The cover member 320 receives a second spring(s) 340. A portion of the force transmitting member 330 may be inserted into the cover member 320. The portion of the force transmitting member 330 is slidable within the cover member 320. Specifically, the cover member 320 has a receiving hole(s) 322 receiving the second spring(s) 340. While it is shown in the embodiment that the cover member 320 has two receiving holes 322 for receiving the second spring 340, the embodiment of the present invention is not limited to this. The cover member 320 may have the receiving holes 322 of which the number is the same as the number of the second springs 340.

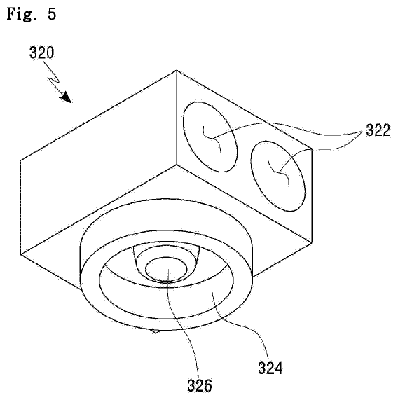

The portion of the force transmitting member 330 may be slidably inserted into the receiving hole 322 of the cover member 320. The cover member 320 is installed within the pedal unit 100. FIG. 5 is a perspective view of the cover member 320 of FIG. 3 as viewed from below.

Referring to FIG. 5, the cover member 320 includes an installation portion 324 and an installation protrusion 326. The installation portion 324 is formed in the lower portion of the cover member 320. The first spring 200 is installed in the installation portion 324. The installation protrusion 326 fixes the first spring 200. As described above, the cover member 320 is received within the pedal unit 100. The first spring 200 is installed under the cover member 320. The installation portion 324 is formed in the lower portion of the cover member 320 such that the first spring 200 is stably installed under the cover member 320.

The force transmitting member 330 is positioned between the friction member 310 and the second spring 340 and transmits the elastic force of the second spring 340 to the friction member 310. The force transmitting member 330 is coupled to the second spring 340 and contacts the friction member 310.

The force transmitting member 330 has an insertion portion 332 which is slidably inserted into the receiving hole 322. The insertion portion 332 has a shape corresponding to the receiving hole 322 of the cover member 320. In another embodiment, the receiving hole 322 and the insertion portion 332 may have different shapes. Also, in FIG. 3, the receiving hole 322 has a cylindrical shape and the insertion portion 332 has a cylindrical shape in correspondence to the receiving hole 322. However, the embodiment of the present disclosure is not limited to this. For example, the receiving hole 322 and the insertion portion 332 may have a quadrangular columnar shape.

The surface of the force transmitting member 330, which contacts the friction member 310, may have a curvature corresponding to the friction member 310. Selectively, the surface of the force transmitting member 330, which contacts the friction member 310, may have a flat surface.

The second spring 340 provides the elastic force to the friction member 310. The second spring 340 is received in the receiving hole 322 of the cover member 320. One end of the second spring 340 is connected to the force transmitting member 330. The elastic force of the second spring 340 is transmitted to the friction member 310 through the force transmitting member 330. The elastic force of the second spring 340 is transmitted continuously to the friction member 310, so that a hysteresis effect is generated.

Meanwhile, an electronic accelerator pedal position (APP) sensor (not shown) senses the rotation amount of the pedal unit and generates an electrical signal and then transmits to a throttle controller. The throttle controller (not shown) operates an actuator (not shown) on the basis of the electrical signal received from the sensor, so that the opening and closing of a throttle valve is controlled and combustion amount is controlled.

When the driver takes his/her foot off the pedal pad 110, the pedal arm 130 is rotated in the opposite direction to the rotation direction thereof by the elastic force of the pressed first spring 200 and returns to its initial position.

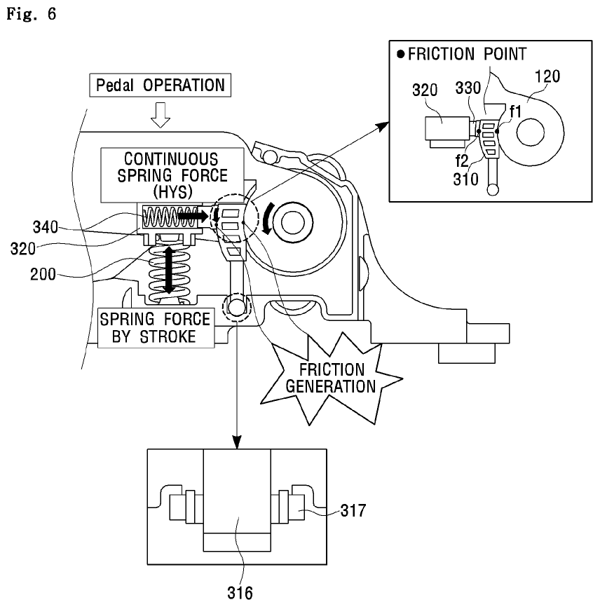

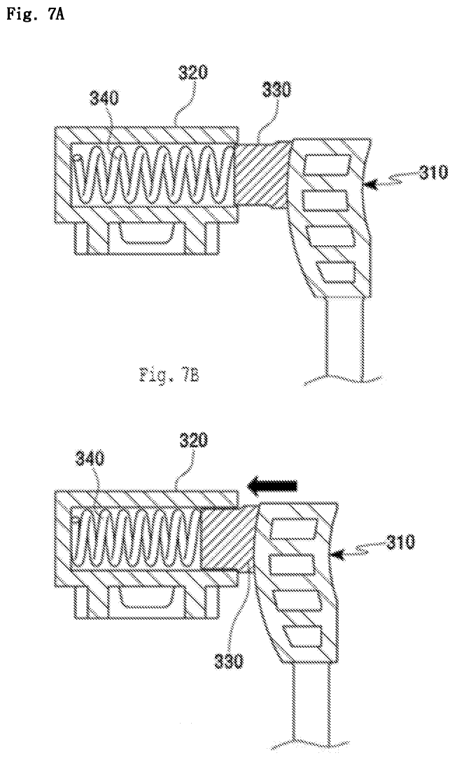

FIGS. 6 and 7 describe the operation of the accelerator pedal for a vehicle of FIG. 1.

FIG. 6 is a view for describing a principle of hysteresis generation in the accelerator pedal for a vehicle according to the embodiment of the present disclosure. FIG. 7 is a view showing the position relationship between the friction member and the force transmitting member.

Referring to FIGS. 6 and 7, it is shown that the driver applies a force to the pedal pad for acceleration.

Referring to FIG. 6, when the pedal unit 100 is rotated by the pedal effort, the hinge 120 of the pedal unit 100 rotates counterclockwise. When the hinge 120 of the pedal unit 100 rotates counterclockwise, a first frictional force f1 is generated between the friction member 310 and the hinge 120 of the pedal unit 100.

Also, the first frictional force f1 generated between the friction member 310 and the hinge 120 of the pedal unit 100 generates a second frictional force f2 between the friction member 310 and the force transmitting member 330.

The position relationship between the friction member 310 and the force transmitting member 330 before the force is applied to the pedal pad 110 of the pedal unit 100 is shown in FIG. 7A. The position relationship between the friction member 310 and the force transmitting member 330 after the force is applied to the pedal pad 110 of the pedal unit 100 is shown in FIG. 7B.

As shown in FIG. 7, when the pedal unit 100 is rotated by applying the force to the pedal pad 110 of the pedal unit 100, the hinge 120 of the pedal unit 100 is rotated. When the hinge 120 of the pedal unit 100 is rotated, the first frictional force f1 is generated between the hinge 120 and the friction member 310 in contact with the hinge 120.

The friction member 310 in contact with the hinge 120 is pivoted about its own shaft 317 by the first frictional force f1. When the friction member 310 is pivoted, the second frictional force f2 is generated between the friction member 310 and the force transmitting member 330 in contact with the friction member 310.

That is, the first frictional force f1 generates the second frictional force f2 between the friction member 310 and the force transmitting member 330. The first frictional force f1 and the second frictional force f2 generate the hysteresis effect in the accelerator pedal for a vehicle.

Meanwhile, the force transmitting member 330 may be pushed within the receiving hole 322 of the cover member 320 in a direction of an arrow, i.e., the direction in which the second spring 340 is pressed. When the force transmitting member 330 is pushed in the direction of the arrow, the second spring 340 is pressed.

Then, after being pressed, the second spring 340 is restored by its restoring force and generates the hysteresis.

As such, the hysteresis effect can be generated by the simple structure.

The features, structures and effects and the like described in the embodiments are included in one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. An accelerator pedal for a vehicle, the accelerator pedal comprises:
a housing which comprises a pivot shaft;
a pedal unit which comprises a hinge connected pivotably to the housing;
a first spring which is positioned under the pedal unit in such a manner as to be pressed downward when the pedal unit is pivoted;
a friction member which is pivotably connected to the housing and contacts the hinge;
a second spring which provides an elastic force to the friction member; and
a force transmitting member which is positioned between the friction member and the second spring and transmits the elastic force of the second spring to the friction member.

2. The accelerator pedal for the vehicle of claim 1, further comprising:
a cover member which receives the second spring and into which a portion of the force transmitting member is slidably inserted.

3. The accelerator pedal for the vehicle of claim 2, wherein the pedal unit comprises a pivot hole into which the pivot shaft is inserted.

4. The accelerator pedal for the vehicle of claim 2, wherein the friction member has a first contact surface contacting a portion of the hinge and a curvature corresponding to a curvature of the hinge and has a second contact surface contacting the force transmitting member.

5. The accelerator pedal for the vehicle of claim 2, wherein the cover member has a receiving hole which receives the second spring.

6. The accelerator pedal for the vehicle of claim 5, wherein the force transmitting member has an insertion portion which is slidably inserted into the receiving hole.

7. The accelerator pedal for the vehicle of claim 1, wherein the housing has a recess in which the first spring is installed.
